(19) United States
(12) Patent Application Publication
(10) Pub. No.: US 2007/0185832 A1
(43) Pub. Date: Aug. 9, 2007

(54) Managing tasks for multiple file types

(75) Inventor: Westin D. Kriebel, Arlington, MA (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/339,076

(22) Filed: Jan. 24, 2006

(51) Int. Cl. G06F 17/30

(52) U.S. Cl. 707/3

(57) ABSTRACT

Tasks associated with different types of files are managed. The files may include text files, application files, application documents and other files. The files may be located in memory of a local computer or over a network. The tasks for the different files may be identified, stored in a task index and provided to a user. Tasks may be identified using task character strings, formatted tasks within application files, or other task information. The task index is created from the identified tasks and may be queried. The results of the task index query may be provided to a user through an interface. Additionally, the interface may provide all or a portion of the file associated with the task.

### BACKGROUND

Tasks implemented within an electronic document are used to remind a reader of an action that needs to be completed. Previously, tasks have been implemented by software programmers in programming code. A programmer may insert a task comment into a set of code indicating the nature of the task to be completed. Some programs exist for scanning program code and recognizing the inserted comments. For example, a program may recognize comments within program code that include the word “TODO,” and associate the comments as a task. A list of the recognized tasks within the program code may then be presented to a user. This task management is limited to program code and the implementations typically change between different users.

Some personal information management (PIM) applications implement task management features. These applications allow a user to create, view and manage tasks within the application itself. Most task functionality within a PIM application is application specific. Thus, a first PIM application which supports tasks in one format may not recognize task information associated with a second PIM application which handles tasks in a second format.

### SUMMARY

The technology herein, roughly described, pertains to managing tasks associated with different types of files. The files may include text files, application files and documents and other files. The files may be located in memory of a local computer or over a network. The tasks for the different files may be identified, stored in a task index and provided to a user.

A task management module may identify tasks within one or more files. The task management module may then construct a task index from the identified tasks. The module may also query the task index and provide information for each task in an interface. In some cases, the task management module may provide all or a portion of the file associated with the task.

Tasks may be configured within a file in several ways. In one embodiment, a task may be embedded within a text file. In this case, the task may include a task character string which identifies the task. Task information may also be embedded within an application file. In this case, the task maybe generated using an application task feature inherent to the application or other application functionality.

This summary is provided to introduce a selection of concepts in a simplified form that are further described below in the description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1A is a block diagram of an embodiment of a system for managing tasks located on a client computer.

FIG. 1B is a block diagram of an embodiment of a system for managing tasks located over a network.

FIG. 1C is a block diagram of an embodiment of a task management module.

FIG. 2 is a block diagram of an embodiment of a computing environment for implementing the present technology.

FIG. 3 is a table of exemplary types of tasks for use with the present technology.

FIG. 4 is a flowchart of an embodiment of a process for managing document tasks.

FIG. 5A is a flowchart of an embodiment of a process for constructing a task index.

FIG. 5B is a flowchart of an embodiment of a process for adding text file tasks to a task index.

FIG. 5C is a flowchart of an embodiment of a process for adding application file tasks to a task index.

FIG. 6 is a flowchart of an embodiment of a process for querying a task index.

FIG. 7 is a flowchart of an embodiment of a process for providing task information associated with a query.

FIG. 8 is an example of a task management interface.

### DETAILED DESCRIPTION

Task management is provided for tasks associated with different types of files. The files may include text files, application files and documents and other files. The tasks within the different files may be identified, stored in a task index and provided to a user. The files may be accessed from local memory or over a network.

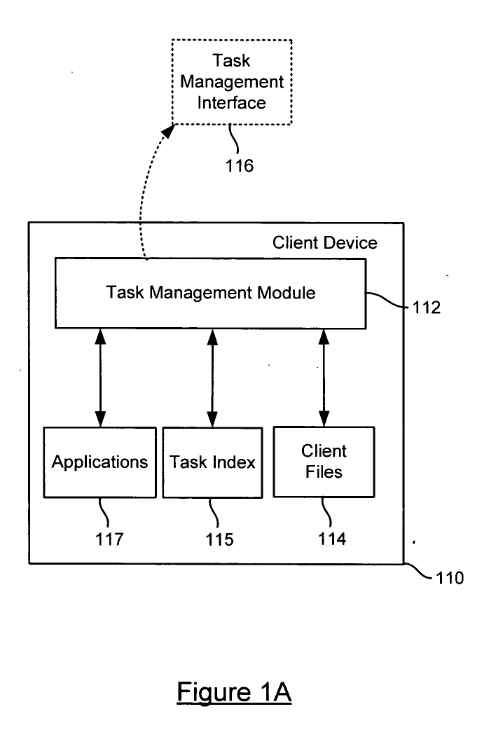

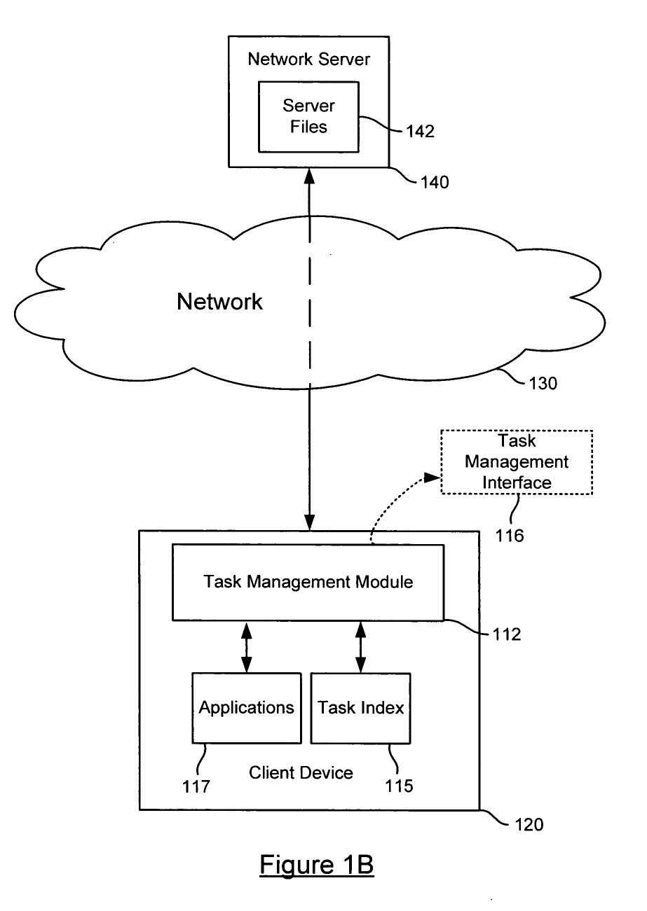

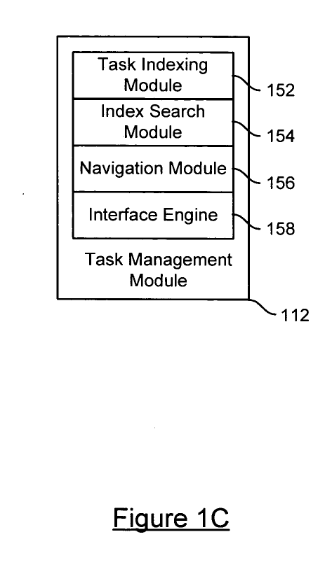

A task management module may identify tasks within one or more files and construct a task index from the identified tasks. A task management module is discussed in more detail below with respect to FIG. 1. The task index may contain task information for the identified tasks. The task management module may also query the task index to provide a filtered list of tasks. More information may be provided for one or more selected tasks from the query results. In some cases, the provided information may include all or a portion of the file associated with the task. In this case, the task management module may provide the file, a page within a file, a line of text from the file or other information associated with the embedded task.

Tasks may be recognized within a file in several ways. In one embodiment, a task may be embedded as text within a text file. In this case, the task may include a task character string. A task character string can be any string of characters which identifies a task. A text file task is identified when the task character string within the file is recognized. For example, the task character string may include the characters, “TASK!” In this case, whenever the characters “TASK!” are identified within a text file, they are associated with a task within the file. In one embodiment, a task management module may recognize different task character strings, wherein each string may be associated with a different type of task or information. In some embodiments, a task character string may be associated with additional task information. The task information may be included in the same line as the task string, in a number of subsequent lines after the task string, or within the text file in some other manner such that it may be retrieved by the task management module.

A task may also be recognized while embedded within an application file. The application file may be a document associated with the application, a task type file associated with the application, or some other application related file. The task may be generated using task generation features inherent in the application or other application features. When embedded within the application file using task generation features, the application creates the task and inserts the task in the application file in response to user input. In this case, the task information may be saved as part of an application file or as a task type file associated with the application.

A user may insert a task into an application file using other means as well. Application features such as commenting, flagging and other features may be used to insert task information into an application file. In this case, when a user utilizes other means to insert task information, the task can be identified by including a character string in the task information. Application files which can include task information include word processor files, slide show application files, spreadsheet application files and other files.

A task may be associated with task information. The task information may include the task creator, task title, the date the task was created, information regarding completing the task, when the task is to be completed, how long the task is estimated to take, other information required to complete the task, who the task is assigned to and other information. In some cases, all or some of the task information may be included as meta-data. Meta-data may be associated with a task by an application that supports task generation features.

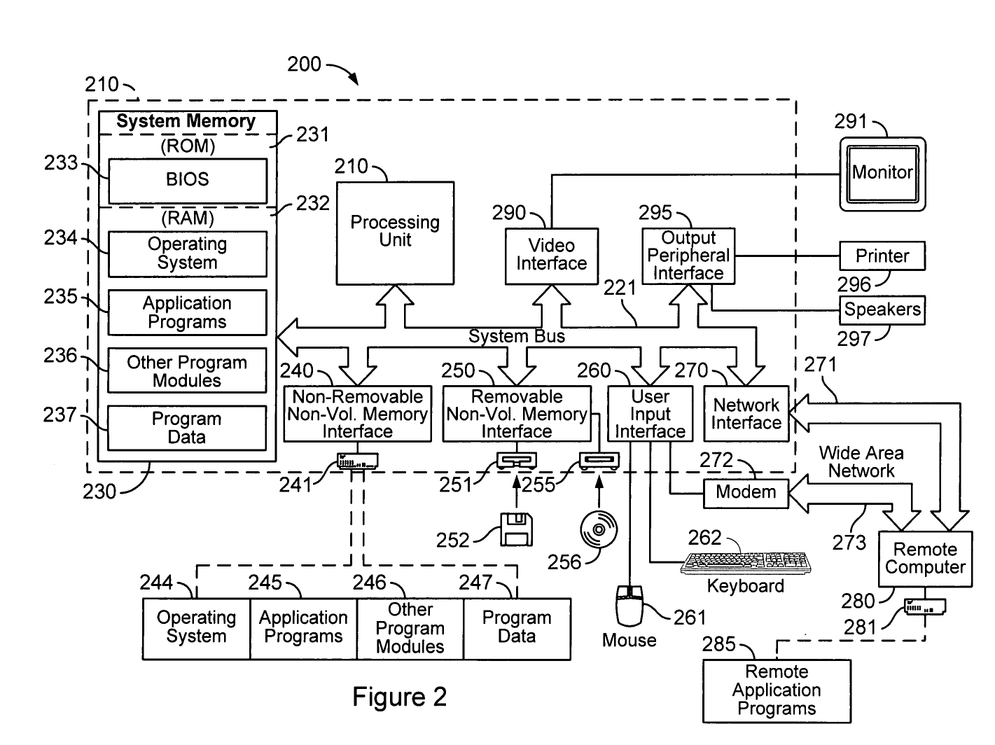

FIG. 1A is a block diagram of an embodiment of a system for managing tasks on a client computer. The system of FIG. 1A includes client device 110. Client device 110 may be implemented by a computing environment such as that discussed below with respect to FIG. 2. Client device 110 includes task management module 112, client files 114, task index 115 and applications 117.

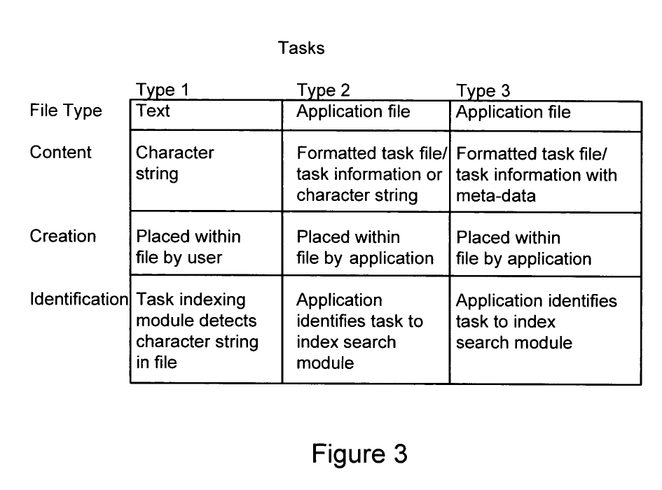

Task management module 112 may access client files 114 on client device 110, construct task index 115 from client files 114, query task index 115 and provide task information through an interface. Task management module 112 may be implemented by a software application, an operating system, or some other software. For example, when implemented as part of an operating system, task management module 112 may be implemented as part of a desktop search feature. The functionality of task management module 112 is discussed in more detail below with respect to FIG. 1C and FIG. 3.

Client files 114 are implemented in local memory of client device 110. Client files 114 may include text files, application files (including application documents) and other files having task information. The tasks and/or task information within any of the files of client files 114 may be accessed by task management module 112. The accessed tasks and/or task information may then be placed into task index 115 which can be queried by a user. Any file or portion of a file of client files 114 may also be provided to a user by task management module 112. In particular, the task management module may provide task information to a user by displaying an image of an application document (such as one slide of a slide presentation document), a page of an application file (such as a word processing document), a line within a text document or some other portion of a file which includes task information.

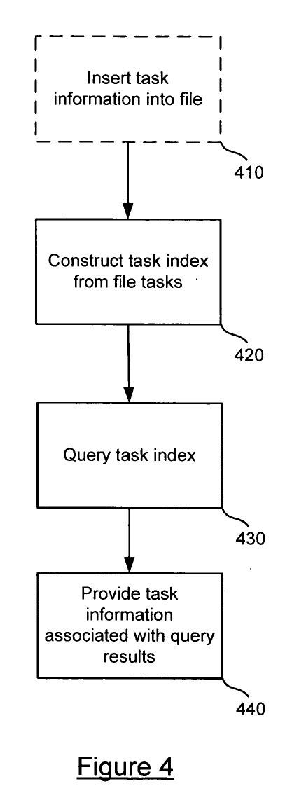

Task index 115 is includes task information for tasks identified by task management module 112. The task information included within task index 115 may range from task details, details associated with the file in which the task is contained, and other data. In some embodiments, the task information includes task meta-data which provides parameters for the task. Construction and query of task index 115 is discussed in more detail below with respect to FIG. 4.

Applications 117 may include one or more applications that are used to open client files 114. In some embodiments, applications 117 may include a word processing application, slide show document application, personal information management application, spreadsheet application, and other applications. In some embodiments, the applications may include task generation features and/or other features (e.g., comment generation features) that can be used to enter task information into a file or application document.

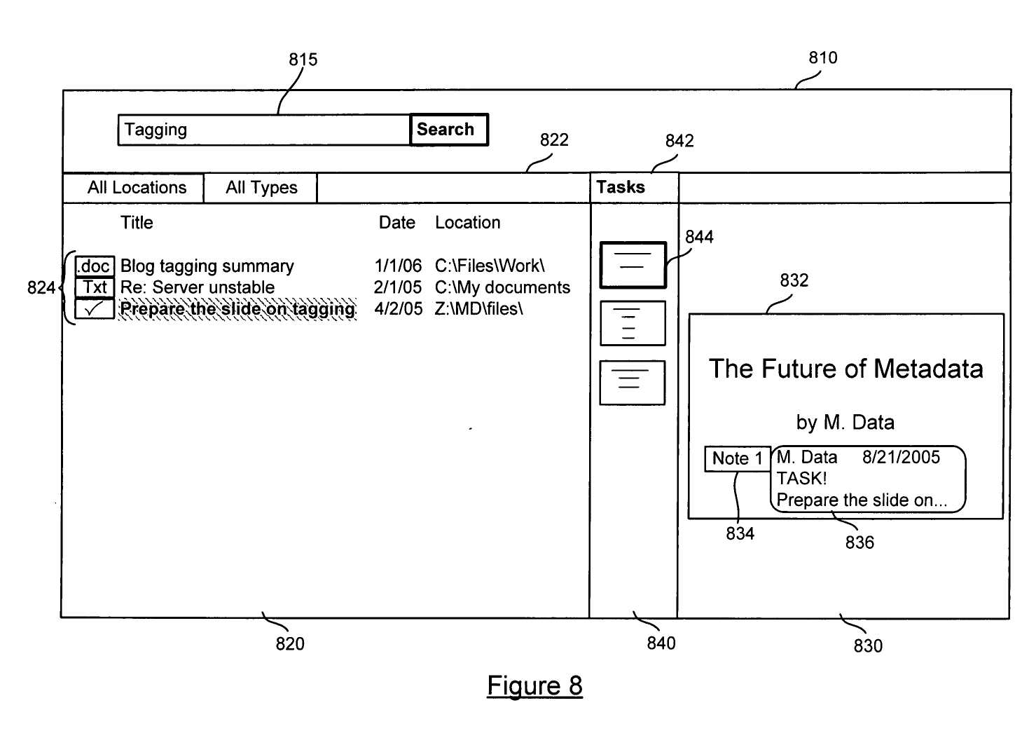

Task management module 112 may also provide task management interface 116. Task management interface 116 may receive input and provide task management information associated with one or more tasks. Task management interface 116 is discussed in more detail below with respect to FIG. 8.

FIG. 1B is a block diagram of an embodiment of a system for managing tasks within files located over a network. The block diagram of FIG. 1B includes client device 120, network server 140 and network 130. Client device 120 may send and receive messages with network server 140 over network 130. In one embodiment, network 130 may be implemented as the Internet. Though only one network server is illustrated in FIG. 1B, more network servers may be included, all of which may send and receive messages with client device 120.

Client device 120 of FIG. 1B is similar to client device 110 of FIG. 1A, and may be implemented using the computing environment discussed below with respect to FIG. 2. Client device 120 includes task management module 112, task index 115 and applications 117. Task management module 112 provides task management interface 116, constructs and may send queries to task index 115, and may send and receive messages with network server 140. In one embodiment, task management module 112 may access files located on network server 140 which include task information.

Task management module 112 may also provide task management interface 116. Task management interface 116 is the same interface as the task management interface of FIG. 1A. Task management interface 116 is discussed in more detail below with respect to FIG. 8.

In one embodiment, applications 117 of FIG. 1B may be the same applications in FIG. 1A. In this case, applications 117 of FIG. 1B may include one or more applications that are used to open client files 114 and may include task generation features and/or other features to enter task information into a file or application document.

Network server 140 includes server files 142 and may send and receive information with client device 120 over network 130. Network server 140 may be implemented as a web server, a database, or some other network machine. Server files 142 may include text files, application files and other files having task information. In one embodiment, server files 142 on network server 140 may be accessed by task management module 112 on client device 120.

FIG. 1C is a block diagram of an embodiment of task management module 112. Task management module 112 of FIG. 1C includes task indexing module 152, index search module 154, navigation module 156 and interface engine 158. Each of modules 152-156 and engine 158 may be implemented in computer code stored on client device 110 or client device 120.

Task indexing module 152 is able to construct task index 115. Construction of task index 115 involves accessing local and/or remote files to determine and retrieve task information associated with the files. Once constructed, task index 115 can be queried by task management module 112. Construction of task index 115 is discussed in more detail below with respect to step 420 of the flowchart of FIG. 4.

Index search module 154 can query task index 115 constructed by task management module 112. In one embodiment, searching task index 115 may include sending a query to task index 115 in response to user input. The query may be built using one or more search terms provided by a user through task management interface 116. Query results, including one or more tasks, may be provided within task management interface 116. Querying task index 115 is discussed in more detail below with respect to step 430 of FIG. 4.

Navigation module 156 can provide task information associated with a task. In one embodiment, the task is selected from query results presented by task management interface 116. In this case, in response to selection of the task, navigation module 156 may access the file associated with the task and provide all or a portion of the file within interface 116 as task information. The information may include the file itself, a page within the file which includes the task, a line within the file which includes the task, or other information. Providing task information is discussed in more detail below with respect to step 440 of the flowchart of FIG. 4.

Interface engine 158 provides an interface for implementing task management interface 116. In particular, input may be received by interface 116 to initiate steps 420-440 of the flowchart of FIG. 4. An example of task management interface 116 is illustrated in FIG. 8 and discussed in more detail below.

FIG. 2 illustrates an example of a suitable computing system environment 200 on which the present technology may be implemented. The computing system environment 200 is only one example of a suitable computing environment and is not intended to suggest any limitation as to the scope of use or functionality of the technology. Neither should the computing environment 200 be interpreted as having any dependency or requirement relating to any one or combination of components illustrated in the exemplary operating environment 200. In one embodiment, the computing environment of FIG. 2 may be used to implement client device 110 of FIG. 1 client device 120 and network server 140 of FIG. 2.

The present technology is operational with numerous other general purpose or special purpose computing system environments or configurations. Examples of well known computing systems, environments, and/or configurations that may be suitable for use with the present technology include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The present technology may be described in the general context of computer-executable instructions, such as program modules, being executed by a computer. Generally, program modules include routines, programs, objects, components, data structures, etc. that perform particular tasks or implement particular abstract data types. The present technology may also be practiced in distributed computing environments where tasks are performed by remote processing devices that are linked through a communications network. In a distributed computing environment, program modules may be located in both local and remote computer storage media including memory storage devices.

With reference to FIG. 2, an exemplary system for implementing the present technology includes a general purpose computing device in the form of a computer 210. Components of computer 210 may include, but are not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or present technology for storage of information such as computer readable instructions, data structures, program modules or other data. Computer storage media includes, but is not limited to, RAM, ROM, EEPROM, flash memory or other memory present technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules that are immediately accessible to and/or presently being operated on by processing unit 220. By way of example, and not limitation, FIG. 2 illustrates operating system 234, application programs 235, other program modules 236, and program data 237.

The computer 210 may also include other removable/non-removable, volatile/nonvolatile computer storage media. By way of example only, FIG. 2 illustrates a hard disk drive 240 that reads from or writes to non-removable, nonvolatile magnetic media, a magnetic disk drive 251 that reads from or writes to a removable, nonvolatile magnetic disk 252, and an optical disk drive 255 that reads from or writes to a removable, nonvolatile optical disk 256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 2, provide storage of computer readable instructions, data structures, program modules and other data for the computer 210. In FIG. 2, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 20 through input devices such as a keyboard 262 and pointing device 261, commonly referred to as a mouse, trackball or touch pad. Other input devices (not shown) may include a microphone, joystick, game pad, satellite dish, scanner, or the like. These and other input devices are often connected to the processing unit 220 through a user input interface 260 that is coupled to the system bus, but may be connected by other interface and bus structures, such as a parallel port, game port or a universal serial bus (USB). A monitor 291 or other type of display device is also connected to the system bus 221 via an interface, such as a video interface 290. In addition to the monitor, computers may also include other peripheral output devices such as speakers 297 and printer 296, which may be connected through an output peripheral interface 290.

The computer 210 may operate in a networked environment using logical connections to one or more remote computers, such as a remote computer 280. The remote computer 280 may be a personal computer, a server, a router, a network PC, a peer device or other common network node, and typically includes many or all of the elements described above relative to the computer 210, although only a memory storage device 281 has been illustrated in FIG. 2. The logical connections depicted in FIG. 2 include a local area network (LAN) 271 and a wide area network (WAN) 273, but may also include other networks. Such networking environments are commonplace in offices, enterprise-wide computer networks, intranets and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the user input interface 260, or other appropriate mechanism. In a networked environment, program modules depicted relative to the computer 210, or portions thereof, may be stored in the remote memory storage device. By way of example, and not limitation, FIG. 2 illustrates remote application programs 285 as residing on memory device 281. It will be appreciated that the network connections shown are exemplary and other means of establishing a communications link between the computers may be used.

FIG. 3 is a table of exemplary types of tasks for use with the present technology. The table of FIG. 3 includes Type 1 tasks, Type 2 tasks and Type 3 tasks. For each task type, the table includes information regarding the file type for each class, the content of the task, creation of the task and identification of the task.

According to the table of FIG. 3, a Type 1 task is embedded within a text file and has content which includes a task character string. In one embodiment, text files may include any file format which includes text content. Examples of text files include .txt, .html and .pdf files.

Any number of characters may comprise a task character string. An example of a task string may be “TASK!” A Type 1 task may be created by entering text or causing text to be entered into a text file by a user. A Type 1 task can be identified when task indexing module 152 detects the task character string within the text file containing the task. To do this, the task management module detects the character string while parsing the text document. The module then retrieves task information regarding the task. In one embodiment, the retrieved task information may include the file name and path associated with the text file, the line number in which the task occurs within the file, the rest of the line in the file containing the task and other information.

From the table of FIG. 3, a Type 2 task may be embedded in an application file and may include a formatted task file, task information, or a task character string. In one embodiment, when a user generates task information within an application file using an application, the application may or may not support task generation. If the application does support task generation, the task information may be generated by embedding the task information within the application file or generating a separate task type file. Thus, a Type 2 task may include a task type file or task information embedded in the application file. If the application does not support task generation, the task information may be embedded within the application file using other application features. For example, task information may be included within an application file as a note, a comment, text within the document, or some other format. In this case, the task information may include a task character string to indicate the information is associated with a task.

The application file for a Type 2 task may be identified as a task in several ways. In one embodiment, the task information may be stored as a task type file associated with an application. In this case, the application which creates the task information generates the task type file. Task management module 112 can then identify the task type file when constructing task index 115. In another embodiment, task management module 112 may scan the content of an application file for actual tasks or task character strings. In one embodiment, task management module may scan application file content for actual tasks or task character strings by executing script code or other programming code that may execute another application. For example, the script code may run the application associated with the application file and open the application file. After opening the file, the script code may detect any tasks formatted within the file (if appropriate), and/or scan the content of the file for task character strings. If either an actual task or a task character string is identified within the file, the task management module will incorporate the task information into the task index.

A Type 3 task is similar to a Type 2 task except that a Type 3 task may include meta-data. A Type 3 task exists within an application file. The application file may be an application document or a task type file associated with an application. Task information associated with the task may be created and embedded within the application file using application task generation features. In one embodiment, task information for a Type 3 task may be created and identified as discussed above with respect to Type 2 tasks. The meta-data associated with a Type 2 task may include information such as who the task is assigned to, how long the task may take to complete, projects to which the task is assigned, and other data.

FIG. 4 is a flowchart of an embodiment of a process for managing document tasks. In step 410, one or more tasks are inserted into one or more files. Step 410 can be performed by a user without using task management module 112. As discussed above, a user may insert task information within a text file by inserting information manually. A user may insert task information into an application file by creating a task using task generation features inherent in the application or other application features. Since step 410 is not performed by a task management module, it is represented by a dashed line in FIG. 4.

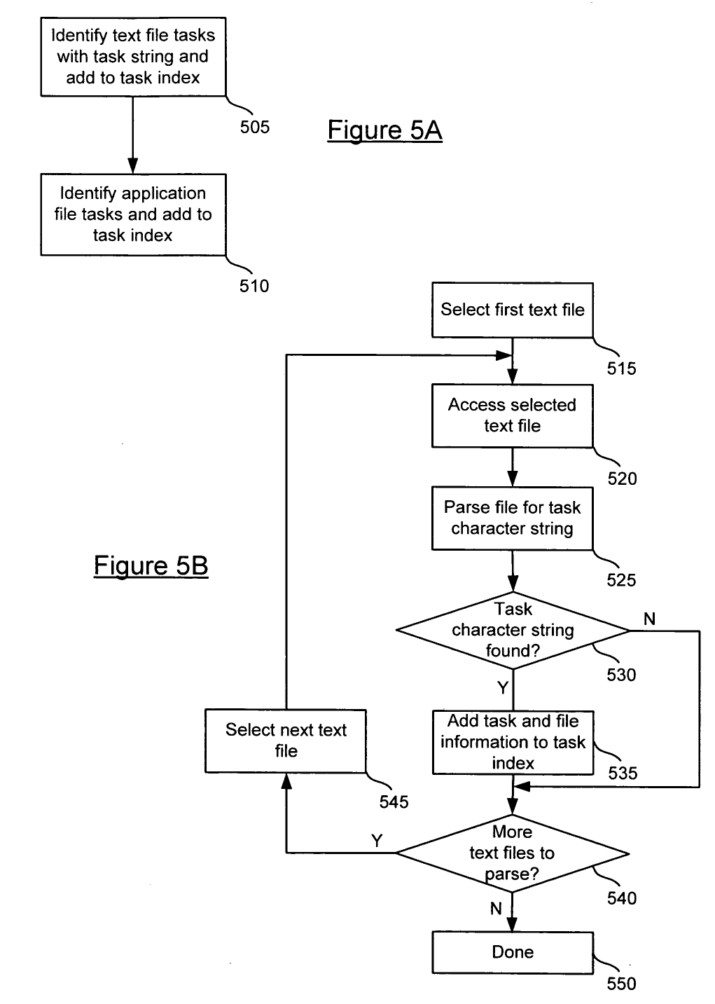

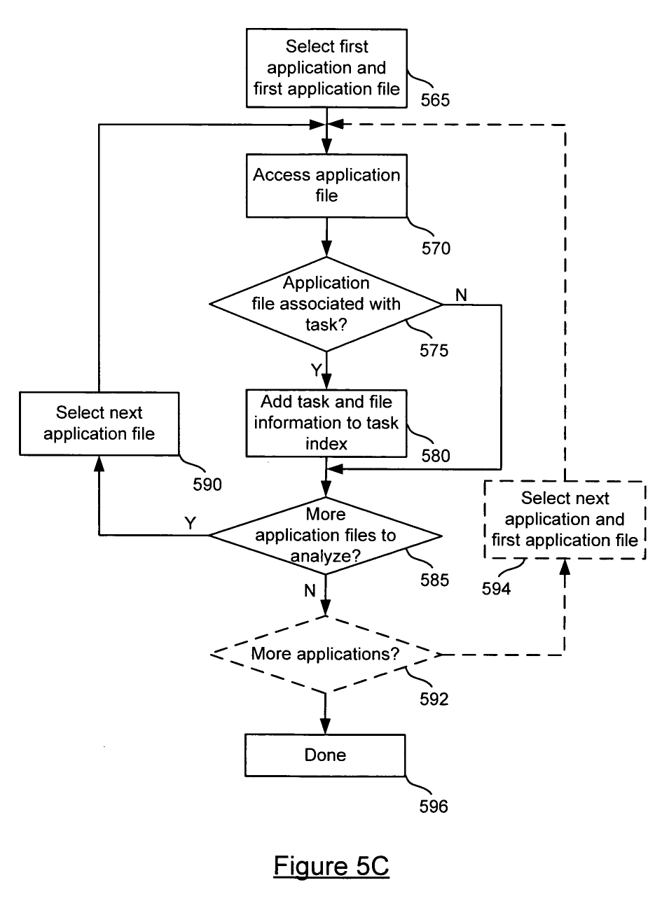

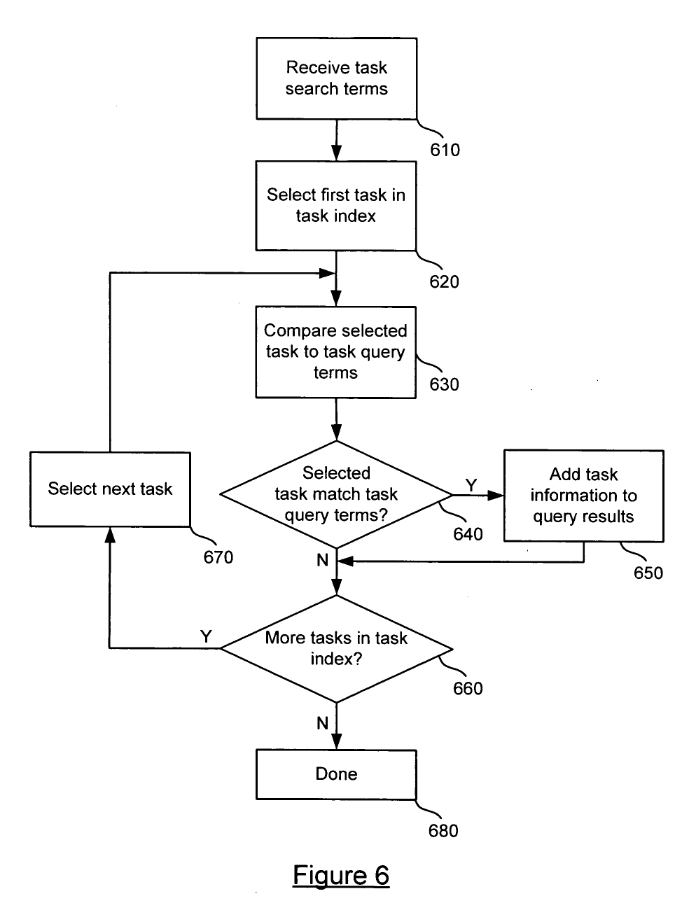

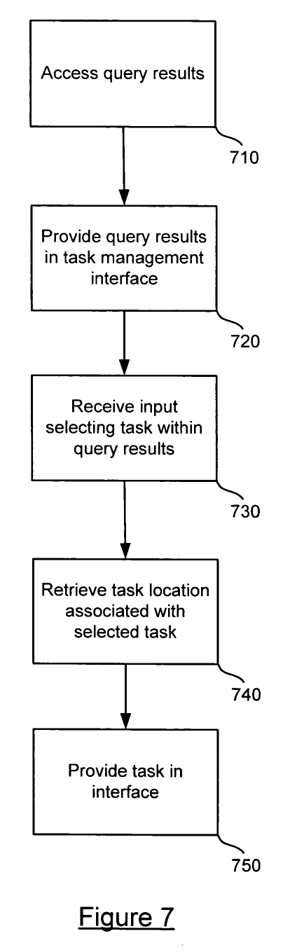

Next, task index 115 is constructed from file tasks at step 420. To construct task index 115, tasks are identified from text files and application files. The files containing the tasks may be accessed locally or remotely over network 130. Task information from within the accessed files is included in task index 115. Constructing task index 115 is discussed in more detail below with respect to FIGS. 5A-C. After constructing the task index, the task index may be queried at step 430. In one embodiment, querying task index 115 is performed in response to receiving query terms and/or instructions from a user. Once the query terms have been received, the task index is queried using the received query terms. More detail associated with querying task index 115 is discussed below with respect to FIG. 6.

After querying task index 115, task information is provided in an interface at step 440. The task information is associated with query results from step 430. The provided task information may include file names and paths, a thumbnail of an image, a line number within a document, metadata associated with a task or other information. Providing task information associated with query results is discussed in more detail below with respect to FIG. 7.

FIG. 5A is a flowchart of an embodiment of a process for constructing task index 115. In one embodiment, the flowchart of FIG. 5A provides more detail for step 420 of FIG. 4. First, text file tasks with a task character string are identified and added to task index 115 at step 505. The text file tasks may be contained in local text files or remote text files. More detail for step 505 of FIG. 5A is discussed below with respect to FIG. 5B. After text file tasks are indexed, application file tasks are identified and added to task index 115 at step 510. As with text file tasks, application file tasks may be retrieved from local files and remote files. The application file tasks may be tasks embedded in an application file using application task features or other application functionality. More detail for step 510 is provided below with respect to FIG. 5C.

FIG. 5B is a flowchart of an embodiment of a process for adding text file tasks to task index 115. In one embodiment, the flowchart of FIG. 5B provides more detail of step 505 of FIG. 5A. First, a first text file is selected at step 515. As discussed above, text files may be selected from local client files 114 or remote server files 142. In one embodiment, text files may be selected by task indexing module 152 of FIG. 1C. In some embodiments, a user may specify locations at which to search for tasks within task management interface 116. After the first text file is selected, the selected text file is accessed at step 520. In one embodiment, accessing the selected text file can include loading the file into local memory. The accessed file is then parsed for a task character string at step 525. In one embodiment, parsing the file for a task character string includes analyzing the file content and determining if it includes the task character string.

A determination is made as to whether the task character string is found within the selected text file at step 530. If the task string is not found within the selected text file, the flowchart of FIG. 5B continues to step 540. If the task string is found, the flowchart of FIG. 5B continues to step 535. If a task character string is found within a text file, task information and file information associated with the task are added to the task index at step 535. In one embodiment, the file information associated with the task includes the file name and path name of the file. The task information may include who created the task, the task creation date, the line number in which the task exists within the document, the entire line containing the task string, and other information. In some embodiments, task information and file information are included in the task index for each task character string found. After adding information to the task index, the flowchart at FIG. 5B continues to step 540.

A determination is made as to whether more text files exist to be parsed at step 540. The determination may involve detecting more files in the current directory, files located in a different directory on the same computer, or files located at a different location over a network. If more text files exist to be parsed at step 540, the next text file is selected at step 545 and the flowchart of FIG. 5B continues to step 520. If no further text files are to be parsed, the flowchart of FIG. 5B is done at step 550.

FIG. 5C is a flowchart of an embodiment of a process for adding application file tasks to task index 115. In one embodiment, the flowchart of FIG. 5C provides more detail for step 510 of FIG. 5A discussed above. First, a first application and first application file are selected at step 565. The application file may be selected from local client files 114 or remote server files 142. In some embodiments, access of an application file by task management module 112 includes opening the file using the corresponding application. As discussed above, this may be done using script code or other code able to run applications and/or open application files using the application. In some embodiments, the application file can be accessed without using the corresponding application. In this case, the format and structure of the application file can be analyzed to determine whether the file includes task information.

Next, the selected application file is accessed at step 570. In one embodiment, accessing the application file may include opening the application file using script code which manipulates the application which supports the application file. In another embodiment, accessing the application file includes loading the file into memory. In this case, the application used to open the file is not required. Next, a determination is made as to whether the accessed application file is associated with a task at step 575. In one embodiment, the determination may involve detecting whether the file includes task information which was created using application task generation features and/or whether a user has inserted task information within the document using other application features.

In some embodiments, determining whether the application file is associated with a task or task character string includes scanning the content of the application for a task (and/or task character string) using script code. In some embodiments, determining whether the application file is associated with a task or task information includes parsing the structure of the application file. In this case, the task management module would go through the data of the application file to determine if a task or task character string was included in the application file.

If the application file is not associated with a task, the flowchart of FIG. 5C continues to step 585. If the application file is associated with a task, operation continues to step 580. Task information and file information are added to the task index at step 580. The task information may include details associated with a task, such as the task creator, creation date, task title, task content, and other data. In some embodiments, the task information may also include meta-data or a task character string. After adding task information and file information to the task index at step 580, the flowchart of FIG. 5C continues to step 585.

A determination is made as to whether more application files exist to be analyzed at step 585. In one embodiment, when application files are accessed through the application which opens the application file, the determination at step 585 involves whether or not there are more application files for the particular application type. For example, if a word processing application was selected at step 565, the determination at step 585 would involve whether more word processing documents associated with the word processing application exist. If more application files exist to be analyzed, either locally or remotely, the next application file is selected at step 590 and the flowchart of FIG. 5C continues to step 570.

If more application files do not exist to be analyzed, a determination is made as to whether there are more applications to be selected at step 592. In this case, the task management module may be configured to access tasks by opening an application file using the application. Thus, once all application files for a selected application have been accessed, a second application can be selected. Application files associated with the second application are then accessed. In some cases, the application associated with an application file is not needed to access task information embedded in the application file. Step 592 is therefore optional, as indicated by the dashed line comprising the step in the flowchart of FIG. 5C. If more applications exist to be selected, the flowchart of FIG. 5C continues to step 594. At step 594, the next application and the first application file for that application are selected. Similar to step 592, step 594 is optional, as indicated by the dashed lines comprising the step in FIG. 5C. The flowchart then continues to step 570. If at step 592 no further applications exist to be processed, the flowchart of FIG. 5C is done at step 596.

FIG. 6 is a flowchart of an embodiment of a process for querying task index 115. In one embodiment, the flowchart of FIG. 6 provides more detail for step 430 of FIG. 4 discussed above. First, query terms are received at step 610. The query terms are received by task management module 112. In one embodiment, the query terms may be received by index search module 154. The terms can be received as user input through task management interface 116. The query terms may include the type of file to retrieve, the locations to search, file data information, metadata associated with the file or whether or not the task includes metadata, the creator of the task and/or other information. Next, the first task in task index 115 is selected at step 620. Next, the selected task is compared to the query terms at step 630.

A determination is made as to whether the selected task matches the query terms at step 640. If the selected task does not match the query terms, the flowchart of FIG. 6 continues to step 660. If the selected task does match the query terms, the task information associated with the matching task is added to query results at step 650. In one embodiment, task management module 112 generates a list or an array of tasks and task information which match the current query. The flowchart of FIG. 6 then continues to step 660. A determination is made as to whether more tasks exist in the task index to be compared to the query terms at step 660. If no further tasks exist to be compared, the flowchart of FIG. 6 is done at step 680. If more tasks in the task index can be compared, the next task is selected at step 670 and the flowchart of FIG. 6 continues to step 630.

FIG. 7 is a flowchart of an embodiment of a process for providing task information to a user. In one embodiment, the flowchart of FIG. 7 provides more detail of step 440 discussed above. First, query results are accessed at step 710. In one embodiment, the query results accessed are the query results generated at step 650 of FIG. 6 by task management module 112. Next, the accessed query results are provided in a task management interface at step 720. In one embodiment, the results are provided in task management interface 116 by interface engine 158. For example, the query results may be provided within a query results window of task management interface 116. This is discussed in more detail below with respect to FIG. 8.

After providing the query results, input may be received selecting a task within the provided query results at step 730. In one embodiment, the input selects a task within a query results window. This is discussed below in more detail with respect to FIG. 8. After receiving the input, task location and optionally other information associated with the selected task is retrieved at step 740. The task location may be a memory location at which task information is stored, the location of the file containing the task, or other location information. In one embodiment, the task location is stored within the task index or a table associated with the task index. After retrieving the task location information, the task is provided in a task management interface at step 750. In one embodiment, more information associated with the task is provided than that in the query results. The additional information may include a thumbnail image of a portion of the application file which provides the task, an application file page which includes the task, a text file line which includes the task or other task information.

FIG. 8 is an example of a task management interface. In one embodiment, the task management interface 810 of FIG. 8 may be used to implement task management interface 116 of FIG. 1A-1B. Task management interface 810 includes search term box 815, query results window 820, navigation window 830 and navigation preview window 840. Search term box 815 includes a text box and a “Search” button. In one embodiment, a user may enter text into the text box. Upon selecting the search button, task management module 112 will query task index 115 using the entered text and other selections within interface 810. For example, the text box currently includes the text “Tagging.” Thus, upon selecting the search button, the query to the task index will result in tasks which include the word “Tagging.”

Query results window 820 includes query toolbar 822 and query results 824. Query toolbar 822 includes inputs for specifying query terms. In the embodiment illustrated, the inputs are associated with task location and task type. The inputs may be implemented as a drop down menu or some other input mechanism. For example, the current location selected is “All Locations” the current file type selected is “All Types.” “All locations” indicates that tasks associated with a file located at any location, both locally and remote, should be retrieved from the task index. “All types” indicates that tasks embedded in all types of files, text files, application files and other files, should be retrieved from the task index. When the search button of search term box 815 is selected by a user, a query is sent by task management module 112 to task index 115. The query incorporates query terms of the text within the text box of search term box 815 and the inputs selected in query toolbar 822.

Query results 824 include a list of task information associated with a query result. Each line in query results 824 is associated with a different task. In the embodiment illustrated, query results 824 include three lines of task information. The last line of task information is highlighted, as illustrated by the dashed lines overlapping the task information. For each task, a file type indicator, a title, the date created and the file location is shown. The file type indicator displays the type of file in which the task is embedded. For example, a “.doc” type may be a specific type of application file, a “txt” type is a text file and a graphical icon (such as the checkmark illustrated in the third line of query results) may indicate another type of file which is accessible by the task management module 112 and includes task information that matches the most recent query. The title in the task information indicates the title of the task. The title could be configured to represent the title of the document containing the task. The date indicates when the document containing the task was created or last modified. In some embodiments, the date may indicate when the task was created or last modified. The location information indicates the location of the file in which the task is embedded. As indicated, the files may be a local file (located on a local file drive “C:”) or a remote file (located on a remote drive “Z:”).

Navigation window 830 and navigation preview window 840 provide more information for a selected task within query results window 820. In one embodiment, task management module 112 receives input of a task within a query result and provides the document associated with the selected task in navigation window 830 and navigation preview window 840. In the embodiment illustrated, a slide show document is selected in query results window 820. A thumbnail preview of the slide images of the selected slide show document is provided in navigation preview window 840. As illustrated, the slide show document has three slide show images. The first of the three thumbnail slide images, thumbnail image 844, is provided in more detail within navigation window 830 as slide image 832.

Slide image 832 includes note marker 834 and task information 836. In the embodiment illustrated, the slide show application which supports the slide show document selected in query results window 820 does not include task generation features. In this case, the task information is incorporated into a note. The note represented by note marker 834 is configured as part of the first page of the slide document. Task information 836 includes the details of the task. In particular, task information 836 includes the creator of the task “M. Data,” the creation date of the task “8/21/2005,” a task character string of “TASK!” and the title of the task “Prepare the slide on tagging.” In the embodiment shown, the entire title is not illustrated because of space restraints in the document.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

I claim:

1. A method for managing tasks, comprising:
constructing a task index, the task index including task information for two or more tasks, the two or more tasks associated with files having a different format; and
querying the task index for tasks that match task filter information.

2. The method of claim 1, wherein said step of constructing a task index includes:
accessing each of the two or more files; and
identifying task information in each of the two or more files.

3. The method of claim 2, wherein said step of identifying task information includes:
parsing a text file.

4. The method of claim 2, wherein said step of identifying task information includes:
executing script code to open an application file by an application.

5. The method of claim 1, wherein at least one of the tasks is embedded in a file located over a network.

6. The method of claim 1, wherein at least one of the tasks includes a task character string.

7. The method of claim 1, wherein said step of querying includes:
querying the task index by a task management module in response to user input.

8. The method of claim 1, wherein at least one of the files is an application file.

9. One or more processor readable storage devices having processor readable code embodied on said processor readable storage devices, said processor readable code for programming one or more processors to perform a method comprising:
submitting a query to a task index, the task index including two or more tasks associated with different file formats;
identifying one or more tasks in the task index in response to the query; and
providing the one or more identified tasks in an interface.

10. The one or more processor readable storage devices of claim 9, wherein said step of submitting a query includes:
receiving query terms from a user; and
submitting the query terms to the task index.

11. The one or more processor readable storage devices of claim 9, wherein one of the different file formats include a text file format.

12. The one or more processor readable storage devices of claim 9, wherein said step of identifying one or more tasks includes:
identifying one or more tasks in the task index having task information that matches a set of query terms contained in the query.

13. The one or more processor readable storage devices of claim 9, wherein said step of providing the one or more identified tasks in the interface includes:
receiving a list of tasks in a query response;
providing task information associated with each task in the list of tasks in the interface.

14. The one or more processor readable storage devices of claim 9, wherein said step of providing the one or more identified tasks in the interface includes:
providing at least a portion of a file containing a one of the identified tasks in the interface.

15. The one or more processor readable storage devices of claim 9, the method further comprising:
receiving a selection of one of the identified tasks, wherein the at least a portion of the file provided being associated with the selected task.

16. A method for managing tasks, comprising:
identifying a task character string within a first file having a text format;
identifying task information in an application file, the application file having a second format, the second format not having a text format; and
adding task information associated with the first file and the application file to a task index.

17. The method of claim 16, wherein one of the first file or the application file is located over a network.

18. The method of claim 16, wherein said step of identifying task information in an application file is performed by script code.

19. The method of claim 16, wherein the application file task information includes the task character string.

20. The method of claim 16, wherein the application file task information includes an application task.
